(19) United States
(12) Patent Application Publication
(10) Pub. No.: US 2026/0067653 A1
(43) Pub. Date: Mar. 5, 2026

(54) VEHICLE-TO-EVERYTHING (V2X) AIDED NON-TERRESTRIAL NETWORK (NTN) OPERATION

(71) Applicant: QUALCOMM Incorporated, San Diego, CA (US)

(72) Inventors: Soumya DAS, San Diego, CA (US); Mohsen BAHRAMI, Carlsbad, CA (US)

(21) Appl. No.: 18/824,646

(22) Filed: Sep. 4, 2024

(51) Int. Cl. H04W 4/40; H04W 56/00; H04W 64/00; H04W 84/06

(52) U.S. Cl. CPC H04W 4/40; H04W 56/0015; H04W 64/00; H04W 84/06

(57) ABSTRACT

Disclosed are techniques for wireless communication. In some aspects, a first user equipment (UE) may receive, from a second UE, a non-terrestrial network (NTN) communication assistance availability message indicating that NTN communication assistance is available from the second UE. The first UE may transmit, to the second UE, an indication that the first UE is seeking the NTN communication assistance in response to the NTN communication assistance availability message.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a method of wireless communication performed at a first user equipment (UE) includes receiving, from a second UE, a non-terrestrial network (NTN) communication assistance availability message indicating that NTN communication assistance is available from the second UE; and transmitting, to the second UE, an indication that the first UE is seeking the NTN communication assistance in response to the NTN communication assistance availability message.

In some aspects, a method of wireless communication performed at a first user equipment (UE) includes determining whether a non-terrestrial network (NTN) communication is available at the first UE; transmitting, to a second UE, an NTN communication assistance availability message indicating that NTN communication assistance is available based on a determination that the NTN communication is available at the first UE; and receiving, from the second UE, an indication that the second UE is seeking the NTN communication assistance.

In some aspects, a first user equipment (UE) includes one or more memories; one or more transceivers; and one or more processors communicatively coupled to the one or more memories and the one or more transceivers, the one or more processors, either alone or in combination, configured to: receive, via the one or more transceivers, from a second UE, a non-terrestrial network (NTN) communication assistance availability message indicating that NTN communication assistance is available from the second UE; and transmit, via the one or more transceivers, to the second UE, an indication that the first UE is seeking the NTN communication assistance in response to the NTN communication assistance availability message.

In some aspects, a first user equipment (UE) includes one or more memories; one or more transceivers; and one or more processors communicatively coupled to the one or more memories and the one or more transceivers, the one or more processors, either alone or in combination, configured to: determine whether a non-terrestrial network (NTN) communication is available at the first UE; transmit, via the one or more transceivers, to a second UE, an NTN communication assistance availability message indicating that NTN communication assistance is available based on a determination that the NTN communication is available at the first UE; and receive, via the one or more transceivers, from the second UE, an indication that the second UE is seeking the NTN communication assistance.

In some aspects, a first user equipment (UE) includes means for receiving, from a second UE, a non-terrestrial network (NTN) communication assistance availability message indicating that NTN communication assistance is available from the second UE; and means for transmitting, to the second UE, an indication that the first UE is seeking the NTN communication assistance in response to the NTN communication assistance availability message.

In some aspects, a first user equipment (UE) includes means for determining whether a non-terrestrial network (NTN) communication is available at the first UE; means for transmitting, to a second UE, an NTN communication assistance availability message indicating that NTN communication assistance is available based on a determination that the NTN communication is available at the first UE; and means for receiving, from the second UE, an indication that the second UE is seeking the NTN communication assistance.

In some aspects, a non-transitory computer-readable medium stores computer-executable instructions that, when executed by a first user equipment (UE), cause the first UE to: receive, from a second UE, a non-terrestrial network (NTN) communication assistance availability message indicating that NTN communication assistance is available from the second UE; and transmit, to the second UE, an indication that the first UE is seeking the NTN communication assistance in response to the NTN communication assistance availability message.

In some aspects, a non-transitory computer-readable medium stores computer-executable instructions that, when executed by a first user equipment (UE), cause the first UE to: determine whether a non-terrestrial network (NTN) communication is available at the first UE; transmit, to a second UE, an NTN communication assistance availability message indicating that NTN communication assistance is available based on a determination that the NTN communication is available at the first UE; and receive, from the second UE, an indication that the second UE is seeking the NTN communication assistance.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates an example of a wireless communications system that supports unicast sidelink establishment, according to aspects of the disclosure.

FIG. 5 illustrates an example of sensor data sharing message (SDSM) transmission, according to aspects of the disclosure.

FIG. 6 illustrates an example of an SDSM message structure, according to aspects of the disclosure.

FIG. 7 illustrates an example of an SDSM message structure which includes a sensor sharing message and a detected object list, according to aspects of the disclosure.

FIG. 8 illustrates an example of an SDSM message structure which includes source data and detected object data, according to aspects of the disclosure.

FIG. 9 illustrates an example call flow between a vehicle seeking assistance and a vehicle providing assistance, according to aspects of the disclosure.

FIG. 10 illustrates an example call flow between a vehicle providing assistance and a vehicle seeking assistance, according to aspects of the disclosure.

FIG. 11 illustrates an example environment for vehicles providing and seeking assistance, according to aspects of the disclosure.

FIG. 12 illustrates an example of zone coverage for NTN assistance planning, according to aspects of the disclosure.

FIG. 13 illustrates an example method of wireless communication, according to aspects of the disclosure.

FIG. 14 illustrates an example method of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless communication. Some aspects more specifically relate to vehicle-to-vehicle communication when there is no terrestrial cellular coverage. In some examples, a first vehicle may receive a non-terrestrial network (NTN) communication assistance availability message indicating that NTN communication assistance is available from a second vehicle, and transmit to the second vehicle an indication that it is seeking NTN communication assistance in response to the NTN communication assistance availability message.

Particular aspects of the subject matter described in this disclosure can be implemented to realize one or more of the following potential advantages. In some examples, by utilizing sensor data sharing or collective perception capabilities of vehicle-to-everything (V2X) communications, the described techniques can be used to enable a vehicle to request emergency or non-emergency assistance over an NTN via another vehicle while traveling in an area without terrestrial cellular network coverage.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

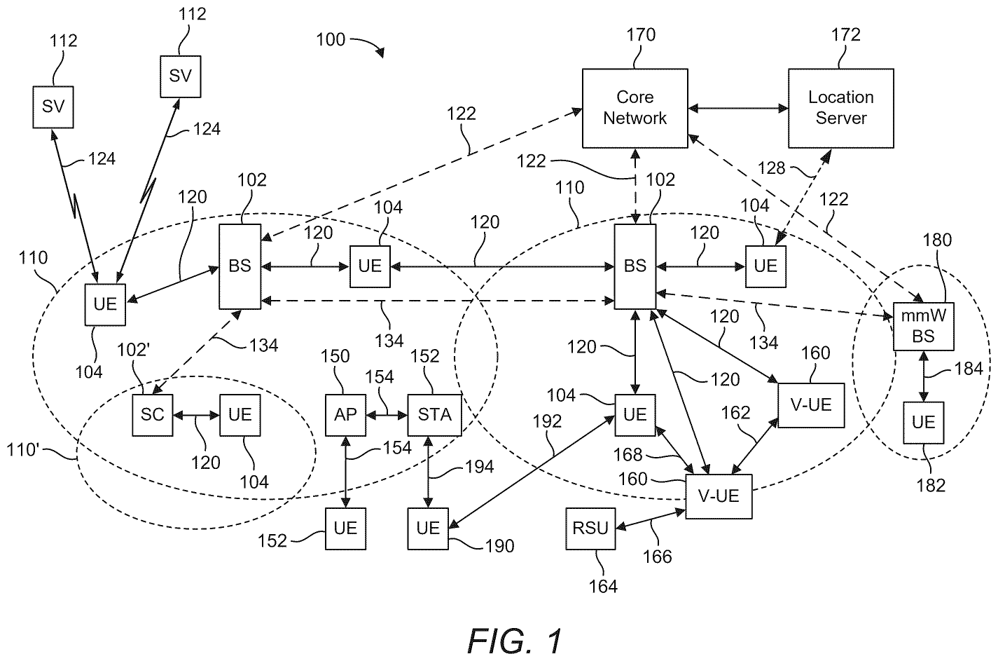

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In some aspects, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In some aspects, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In some aspects, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In some aspects, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In some aspects, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In some aspects, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHZ. However, the present disclosure is not limited to this frequency band or cellular technology.

In some aspects, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHZ (5.85-5.925 GHZ) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHZ.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on. As another example, the D2D P2P links 192 and 194 may be sidelinks, as described above with reference to sidelinks 162, 166, and 168.

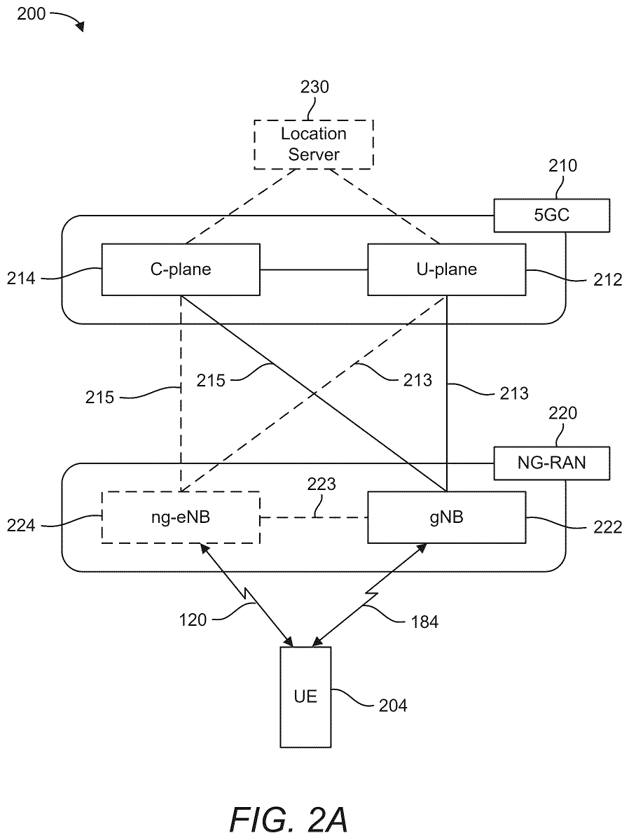

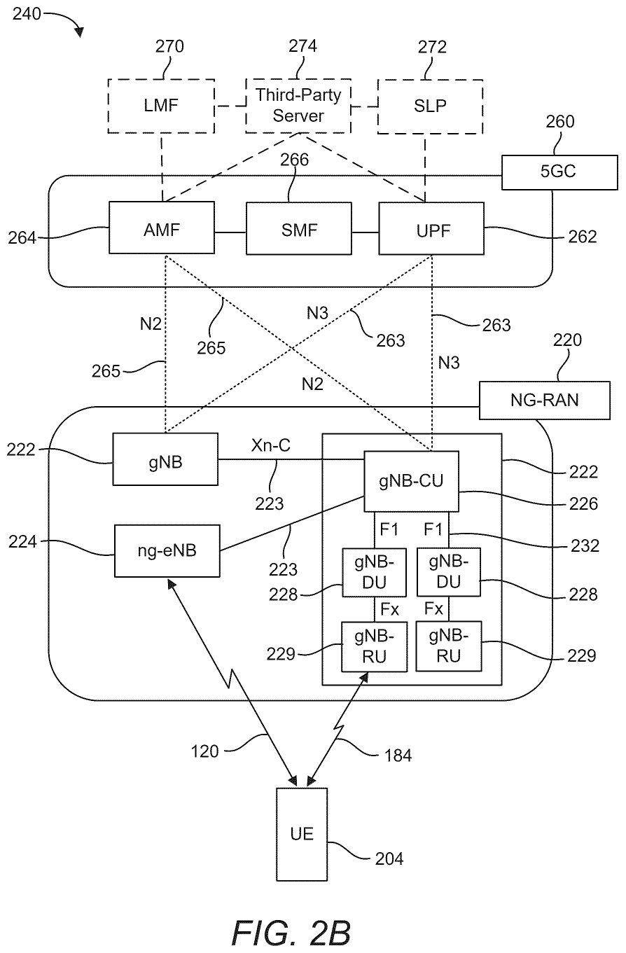

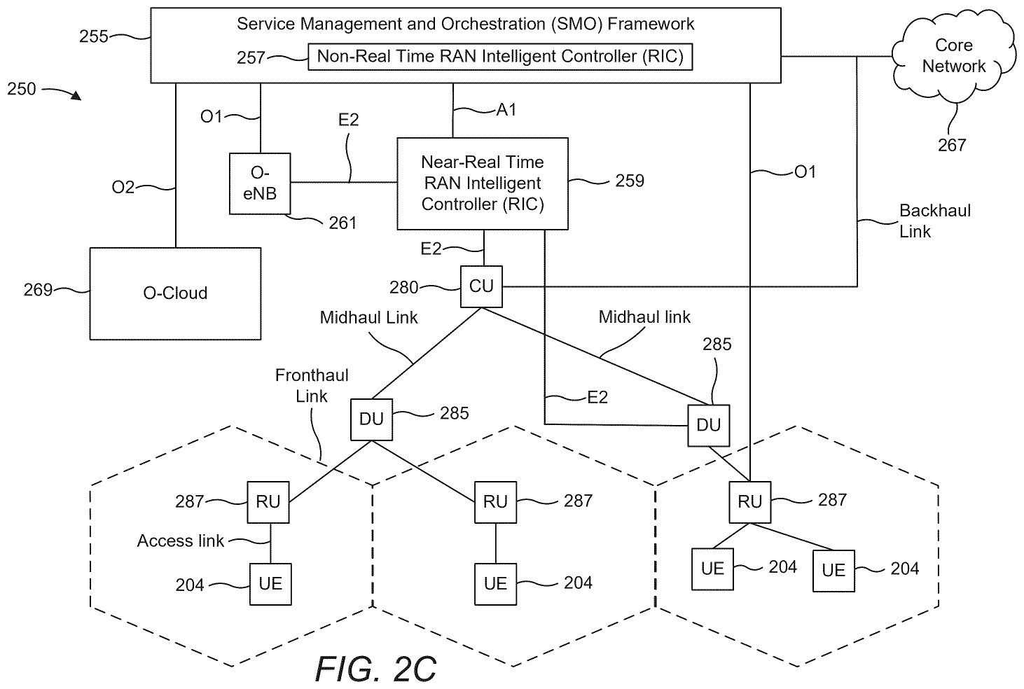

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-cNB(s) 224 and the AMF 264 is referred to as the “N2” interface, and the interface between gNB(s) 222 and/or ng-cNB(s) 224 and the UPF 262 is referred to as the “N3” interface. The gNB(s) 222 and/or ng-cNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

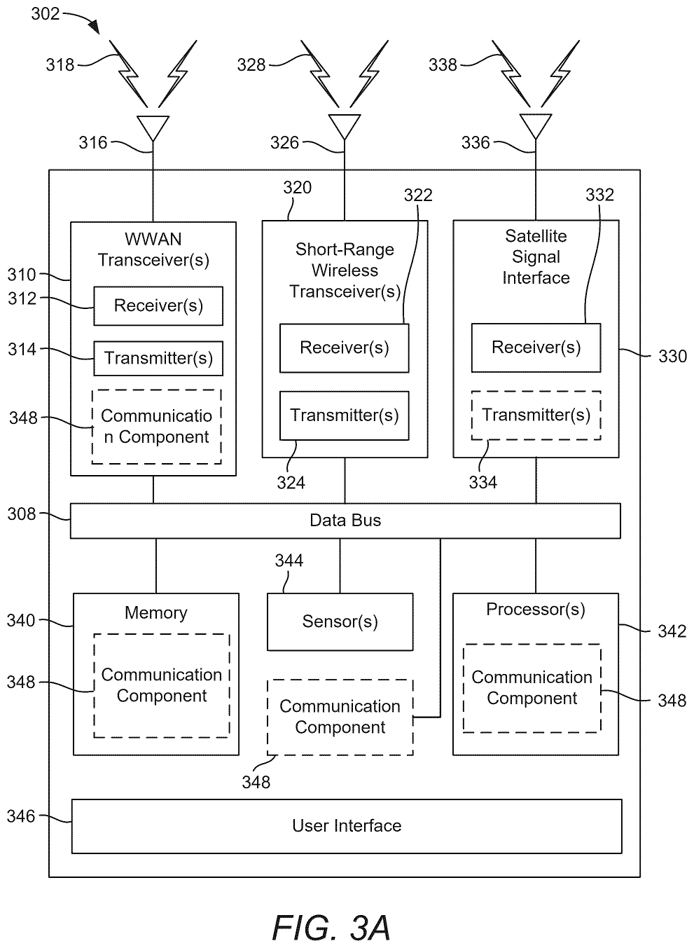

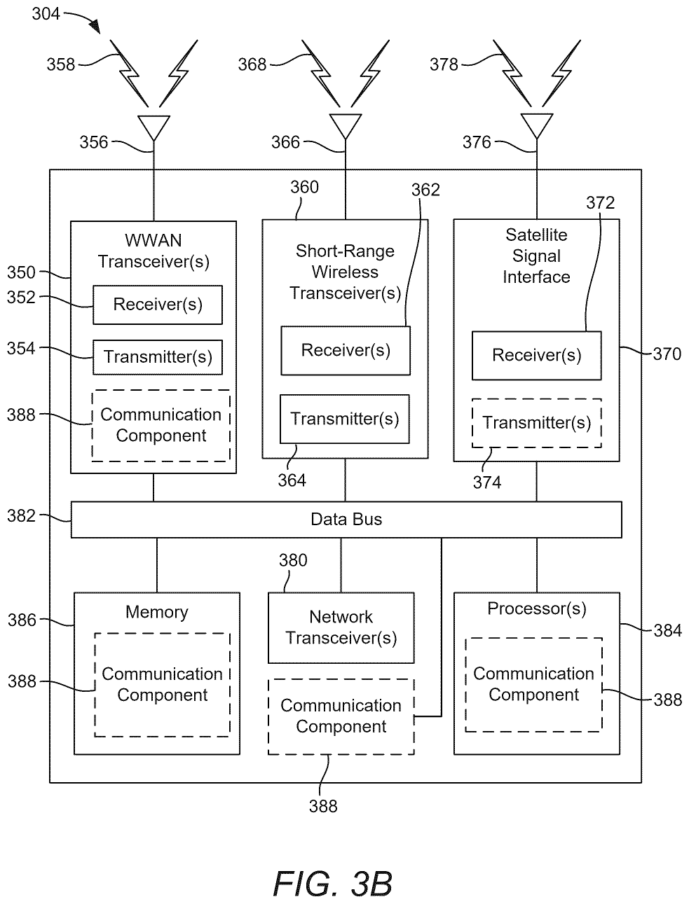

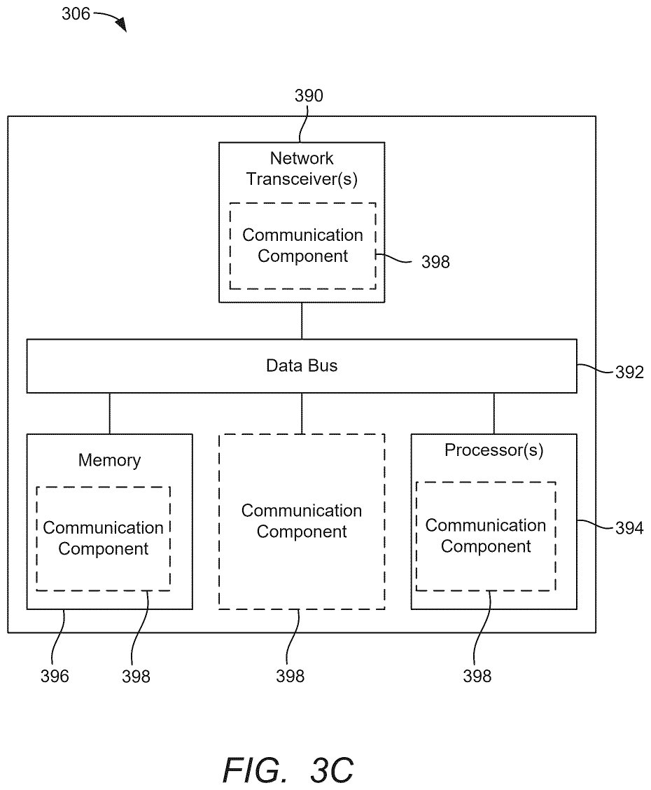

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In some aspects, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In some aspects, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include communication component 348, 388, and 398, respectively. The communication component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the communication component 348, 388, and 398 may be external to the processors 342, 384, and 394 (e.g., part of a modem processing system, integrated with another processing system, etc.). Alternatively, the communication component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the communication component 348, which may be, for example, part of the one or more WWAN transceivers 310, the memory 340, the one or more processors 342, or any combination thereof, or may be a standalone component. FIG. 3B illustrates possible locations of the communication component 388, which may be, for example, part of the one or more WWAN transceivers 350, the memory 386, the one or more processors 384, or any combination thereof, or may be a standalone component. FIG. 3C illustrates possible locations of the communication component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In some aspects, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the communication component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

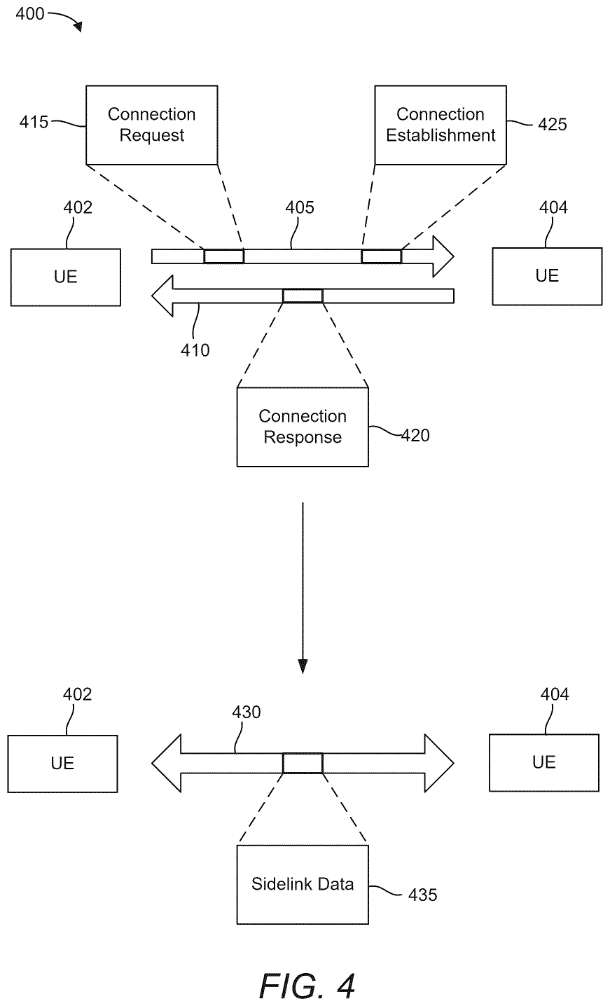

FIG. 4 illustrates an example of a wireless communications system 400 that supports wireless unicast sidelink establishment, according to aspects of the disclosure. In some examples, wireless communications system 400 may implement aspects of wireless communications systems 100, 200, and 250. Wireless communications system 400 may include a first UE 402 and a second UE 404, which may be examples of any of the UEs described herein. As specific examples, UEs 402 and 404 may correspond to V-UEs 160 in FIG. 1.

In the example of FIG. 4, the UE 402 may attempt to establish a unicast connection over a sidelink with the UE 404, which may be a V2X sidelink between the UE 402 and UE 404. As specific examples, the established sidelink connection may correspond to sidelinks 162 and/or 168 in FIG. 1. The sidelink connection may be established in an omni-directional frequency range (e.g., FR1) and/or a mmW frequency range (e.g., FR2). In some cases, the UE 402 may be referred to as an initiating UE that initiates the sidelink connection procedure, and the UE 404 may be referred to as a target UE that is targeted for the sidelink connection procedure by the initiating UE.

For establishing the unicast connection, access stratum (AS) (a functional layer in the UMTS and LTE protocol stacks between the RAN and the UE that is responsible for transporting data over wireless links and managing radio resources, and which is part of Layer 2) parameters may be configured and negotiated between the UE 402 and UE 404. For example, a transmission and reception capability matching may be negotiated between the UE 402 and UE 404. Each UE may have different capabilities (e.g., transmission and reception, 64 quadrature amplitude modulation (QAM), transmission diversity, carrier aggregation (CA), supported communications frequency band(s), etc.). In some cases, different services may be supported at the upper layers of corresponding protocol stacks for UE 402 and UE 404. Additionally, a security association may be established between UE 402 and UE 404 for the unicast connection. Unicast traffic may benefit from security protection at a link level (e.g., integrity protection). Security requirements may differ for different wireless communications systems. For example, V2X and Uu systems may have different security requirements (e.g., Uu security does not include confidentiality protection). Additionally, IP configurations (e.g., IP versions, addresses, etc.) may be negotiated for the unicast connection between UE 402 and UE 404.

In some cases, UE 404 may create a service announcement (e.g., a service capability message) to transmit over a cellular network (e.g., cV2X) to assist the sidelink connection establishment. Conventionally, UE 402 may identify and locate candidates for sidelink communications based on a basic service message (BSM) broadcasted unencrypted by nearby UEs (e.g., UE 404). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 402 is able to detect the BSM(s). Accordingly, the service announcement transmitted by UE 404 and other nearby UEs (e.g., a discovery signal) may be an upper layer signal and broadcasted (e.g., in an NR sidelink broadcast). In some cases, the UE 404 may include one or more parameters for itself in the service announcement, including connection parameters and/or capabilities it possesses. The UE 402 may then monitor for and receive the broadcasted service announcement to identify potential UEs for corresponding sidelink connections. In some cases, the UE 402 may identify the potential UEs based on the capabilities each UE indicates in their respective service announcements.

The service announcement may include information to assist the UE 402 (e.g., or any initiating UE) to identify the UE transmitting the service announcement (UE 404 in the example of FIG. 4). For example, the service announcement may include channel information where direct communication requests may be sent. In some cases, the channel information may be RAT-specific (e.g., specific to LTE or NR) and may include a resource pool within which UE 402 transmits the communication request. Additionally, the service announcement may include a specific destination address for the UE (e.g., a Layer 2 destination address) if the destination address is different from the current address (e.g., the address of the streaming provider or UE transmitting the service announcement). The service announcement may also include a network or transport layer for the UE 402 to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally-generated random protocol. Additionally, the service announcement may include a type of protocol for credential establishment and QoS-related parameters.

After identifying a potential sidelink connection target (UE 404 in the example of FIG. 4), the initiating UE (UE 402 in the example of FIG. 4) may transmit a connection request 415 to the identified target UE 404. In some cases, the connection request 415 may be a first RRC message transmitted by the UE 402 to request a unicast connection with the UE 404 (e.g., an “RRCSetupRequest” message). For example, the unicast connection may utilize the PC5 interface for the sidelink, and the connection request 415 may be an RRC connection setup request message. Additionally, the UE 402 may use a sidelink signaling radio bearer 405 to transport the connection request 415.

After receiving the connection request 415, the UE 404 may determine whether to accept or reject the connection request 415. The UE 404 may base this determination on a transmission/reception capability, an ability to accommodate the unicast connection over the sidelink, a particular service indicated for the unicast connection, the contents to be transmitted over the unicast connection, or a combination thereof. For example, if the UE 402 wants to use a first RAT to transmit or receive data, but the UE 404 does not support the first RAT, then the UE 404 may reject the connection request 415. Additionally or alternatively, the UE 404 may reject the connection request 415 based on being unable to accommodate the unicast connection over the sidelink due to limited radio resources, a scheduling issue, etc. Accordingly, the UE 404 may transmit an indication of whether the request is accepted or rejected in a connection response 420. Similar to the UE 402 and the connection request 415, the UE 404 may use a sidelink signaling radio bearer 410 to transport the connection response 420. Additionally, the connection response 420 may be a second RRC message transmitted by the UE 404 in response to the connection request 415 (e.g., an “RRCResponse” message).

In some cases, sidelink signaling radio bearers 405 and 410 may be the same sidelink signaling radio bearer or may be separate sidelink signaling radio bearers. Accordingly, a radio link control (RLC) layer acknowledged mode (AM) may be used for sidelink signaling radio bearers 405 and 410. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 420 indicates that the UE 404 accepted the connection request 415, the UE 402 may then transmit a connection establishment 425 message on the sidelink signaling radio bearer 405 to indicate that the unicast connection setup is complete. In some cases, the connection establishment 425 may be a third RRC message (e.g., an “RRCSetupComplete” message). Each of the connection request 415, the connection response 420, and the connection establishment 425 may use a basic capability when being transported from one UE to the other UE to enable each UE to be able to receive and decode the corresponding transmission (e.g., the RRC messages).

Additionally, identifiers may be used for each of the connection request 415, the connection response 420, and the connection establishment 425. For example, the identifiers may indicate which UE 402/404 is transmitting which message and/or for which UE 402/404 the message is intended. For physical (PHY) layer channels, the RRC signaling and any subsequent data transmissions may use the same identifier (e.g., Layer 2 IDs). However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a physical layer ACK may be used for ensuring the corresponding messages are transmitted and received properly.

One or more information elements may be included in the connection request 415 and/or the connection response 420 for UE 402 and/or UE 404, respectively, to enable negotiation of corresponding AS layer parameters for the unicast connection. For example, the UE 402 and/or UE 404 may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, the UE 402 and/or UE 404 may include RLC parameters when establishing the unicast connection to set an RLC context for the unicast connection. For example, the RLC context may indicate whether an AM (e.g., a reordering timer (t-reordering) is used) or an unacknowledged mode (UM) is used for the RLC layer of the unicast communications.

Additionally, the UE 402 and/or UE 404 may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (NACK) feedback), parameters for the HARQ feedback scheme, carrier aggregation, or a combination thereof for the unicast connection. Additionally, the UE 402 and/or UE 404 may include PHY layer parameters when establishing the unicast connection to set a PHY layer context for the unicast connection. For example, the PHY layer context may indicate a transmission format (unless transmission profiles are included for each UE 402/404) and a radio resource configuration (e.g., bandwidth part (BWP), numerology, etc.) for the unicast connection. These information elements may be supported for different frequency range configurations (e.g., FR1 and FR2).

In some cases, a security context may also be set for the unicast connection (e.g., after the connection establishment 425 message is transmitted). Before a security association (e.g., security context) is established between the UE 402 and UE 404, the sidelink signaling radio bearers 405 and 410 may not be protected. After a security association is established, the sidelink signaling radio bearers 405 and 410 may be protected. Accordingly, the security context may enable secure data transmissions over the unicast connection and the sidelink signaling radio bearers 405 and 410. Additionally, IP layer parameters (e.g., link-local IPv4 or IPv6 addresses) may also be negotiated. In some cases, the IP layer parameters may be negotiated by an upper layer control protocol running after RRC signaling is established (e.g., the unicast connection is established). As noted above, the UE 404 may base its decision on whether to accept or reject the connection request 415 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, the UE 402 and UE 404 may communicate using the unicast connection over a sidelink 430, where sidelink data 435 is transmitted between the two UEs 402 and 404. The sidelink 430 may correspond to sidelinks 162 and/or 168 in FIG. 1. In some cases, the sidelink data 435 may include RRC messages transmitted between the two UEs 402 and 404. To maintain this unicast connection on sidelink 430, UE 402 and/or UE 404 may transmit a keep alive message (e.g., “RRCLinkAlive” message, a fourth RRC message, etc.). In some cases, the keep alive message may be triggered periodically or on-demand (e.g., event-triggered). Accordingly, the triggering and transmission of the keep alive message may be invoked by UE 402 or by both UE 402 and UE 404. Additionally or alternatively, a MAC control element (CE) (e.g., defined over sidelink 430) may be used to monitor the status of the unicast connection on sidelink 430 and maintain the connection. When the unicast connection is no longer needed (e.g., UE 402 travels far enough away from UE 404), either UE 402 and/or UE 404 may start a release procedure to drop the unicast connection over sidelink 430. Accordingly, subsequent RRC messages may not be transmitted between UE 402 and UE 404 on the unicast connection.

In some aspects, cellular V2X (C-V2X) allows vehicles to communicate with each other without terrestrial network (e.g., cellular or WWAN) coverage. In C-V2X communications, the global navigation satellite system (GNSS) may be used as a primary synchronization source. For locations where no GNSS signal is present, other synchronization sources may need to be used to enable C-V2X communications.

In some aspects, NTN such as narrow-band IoT NTN (NB-NTN) or New Radio-NTN (NR-NTN) may be used for communications when or where no terrestrial cellular network coverage is available or accessible. In some situations, a user may need urgent access to a communication system. For example, a vehicle traveling in an area with no terrestrial cellular coverage may need to request emergency service. In such situations, NTN may be invoked when terrestrial network coverage is not available, or is available but is incapable of providing communications for emergency services. In some situations, NTN may be available only for emergency services.

In some aspects, messages indicating NTN communication assistance capabilities, such as collective perception messages (CPMs) under the European Telecommunications Standards Institute (ETSI) TR 103 562-V2.1.1 standard, or sensor data sharing messages (SDSMs) under the Society of Automotive Engineers (SAE) J3224 standard, for example, may be used for conveying NTN availability and/or NTN assistance information.

In some aspects, while there is cellular network coverage, cellular network outage may be predicted, for example, to plan on seeking NTN assistance before the actual outage occurs. Such planning may be performed over vehicle-to-network (V2N or Uu) while there is cellular coverage, for example.

In some aspects, for NB-NTN operations, a vehicular UE may autonomously pre-compensate for timing advance (TA) and frequency shift due to large cellular coverage areas. In these situations, the vehicular UE may need location information from a GNSS positioning fix as well as additional positioning information from the NTN. If the UE does not have a GNSS positioning fix that coexists with NB-NTN, then the UE may need to tear down its existing NTN session, transition to an idle state, acquire a GNSS positioning fix, and start a new NTN session again. In some aspects, C-V2X may be used in conjunction with NTN to provide communication assistance, for example, emergency communication assistance, for vehicular UEs in areas with no terrestrial cellular network coverage.

In some aspects, accurate knowledge of road conditions and road users (e.g., vehicular UEs) may be needed for RSUs and vehicular UEs to make safe and efficient driving decisions. In some aspects, such decisions may be made by individual vehicles or as part of negotiated, cooperative inter-vehicle maneuvers.

In some aspects, systems and methods based on the SAE J3224 standard V2X Sensor-Sharing for Cooperative & Automated Driving specification may be implemented to enhance situational awareness for V2X entities (e.g., RSUs, vehicles, and/or vulnerable road users (VRUs)), by defining an application-layer message structure and information elements for RSUs and vehicles to exchange information on road users and road obstacles to improve cooperative and automated driving decisions.

In some aspects, SDSMs based on the SAE J3224 standard specification may be used for NTN assistance messaging. In some aspects, CPMs based on the European Telecommunications Standards Institute (ETSI) TR 103 562-V2.1.1 standard specification may be used for NTN communication assistance messaging as an alternative or in addition to SDSM messaging.

In some aspects, an NTN communication assistance availability message (e.g., SDSM and/or CPM) may be transmitted from a vehicular UE that is able to and willing to provide assistance. In some aspects, the NTN communication assistance availability message may include information such as:
Terrestrial cellular network out-of-service (OOS) information if the duration of OOS is over a threshold duration
NTN service provider
NTN availability information—such as E-UTRA absolute radio frequency channel number (EARFCN) of anchor carrier, physical cell ID (PCI), tracking area code (TAC), and/or public land mobile network identifier (PLMN)
Average narrowband reference signal received power (NRSRP) and control element (CE) level
An indication of whether the NTN frequency bands are jammed (true or false)
Willingness to relay message over NTN for vehicular UEs in need (and monetary charges for such assistance, if any)—if yes, additional information such as:
   Indication of whether the assistance-providing UE supports NTN features only for the geosynchronous satellite (GSO) scenario or the Non-GSO (NGSO) scenario
   NTN class of service (corresponding to assistance-providing vehicular UE subscription)
   UE power class information for NTN

In some aspects, the dissemination of some or all of the above-listed information may be made over a short-range communication (e.g., LTE-V2X, also called “PC5”) to help an onboard unit (OBU) make a decision about whether an NTN SoS/P2P service is available (provided that it has an NTN subscription) or whether to request another OBU with an NTN subscription to relay its emergency (e.g., SoS) message.

In some aspects, an NTN communication assistance availability message (e.g., SDSM and/or CPM) may be transmitted from a vehicular UE that is capable of providing NTN communication assistance with NTN information in response to another vehicular UE that is seeking NTN assistance. In some aspects, the vehicular UE that is seeking assistance may transmit a groupcast message indicating that it is seeking NTN communication assistance, such that one or more vehicular UEs within its V2X communication range may detect the groupcast message and provide NTN communication assistance in response.

In some aspects, where the NTN communication assistance availability message is a SDSM, the SDSM message structure may include one or more of the following information elements (IEs):
Common data—static and/or dynamic characteristics common to all detected objects
Detected vehicle data—vehicle-specific detected characteristics
Detected VRU data—vehicle-specific detected characteristics
Detected obstacle data—obstacle-specific detected characteristics
Detected NTN coverage data—NTN-specific detected characteristics

In some aspects, the detected NTN coverage data may be an additional IE incorporated into an existing SDSM for providing NTN communication assistance in the event a terrestrial cellular network coverage is unavailable.

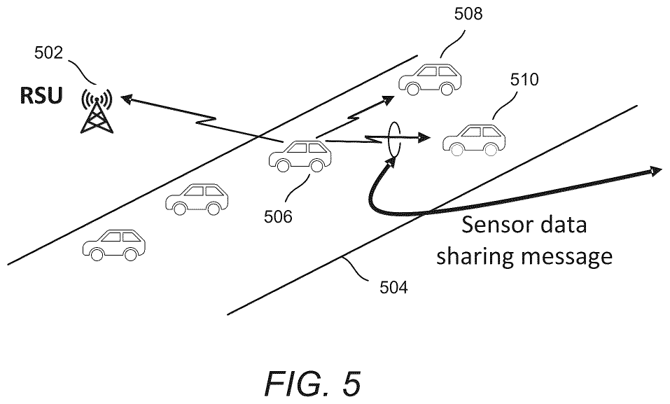

FIG. 5 illustrates an example of SDSM transmission, according to aspects of the disclosure. In the example illustrated in FIG. 5, an RSU 502 is provided on a side of a road 504, where a first vehicular UE 506 transmits an SDSM to the RSU 502, a second vehicular UE 508, and a third vehicular UE 510.

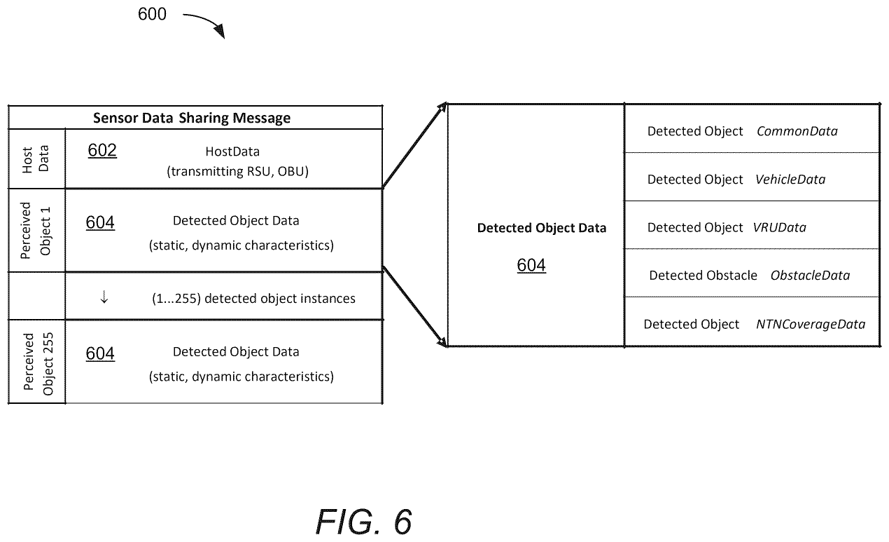

FIG. 6 illustrates an example of an SDSM message structure, according to aspects of the disclosure. In the example shown in FIG. 6, the SDSM 600 may include host data 602 (denoted “Host Data”) and detected object data 604 on a plurality of perceived objects (denoted “Perceived Object 1” . . . “Perceived Object 255”). In some aspects, the host data may include data associated with the transmitting RSU and/or OBU. In some aspects, the detected object data for each perceived object may include static and/or dynamic characteristics of that object. For example, the detected object data 604 may include detected object common data (denoted “Detected Object CommonData”), detected object vehicle data (denoted “Detected Object VehicleData”), detected object VRU data (denoted “Detected Object VRUData”), detected obstacle data (denoted “Detected Obstacle ObstacleData”), and detected object NTN coverage data (denoted “Detected Object NTNCoverageData”), as shown in FIG. 6.

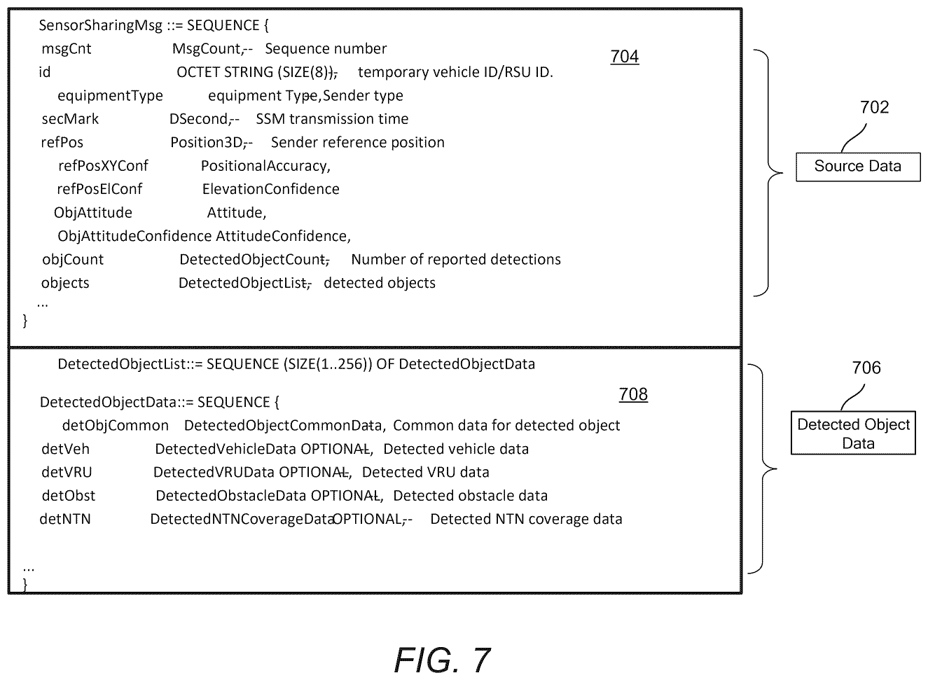

FIG. 7 illustrates an example of an SDSM message structure which includes a sensor sharing message and a detected object list, according to aspects of the disclosure. In the example shown in FIG. 7, source data 702 includes a sensor sharing message (denoted “SensorSharingMsg”) in block 704, whereas detected object data 706 includes a detected object list (denoted “DetectedObjectList”) in block 708. Various types of information may be included in the source data 702 and/or the detected object data 706 according to aspects of the disclosure.

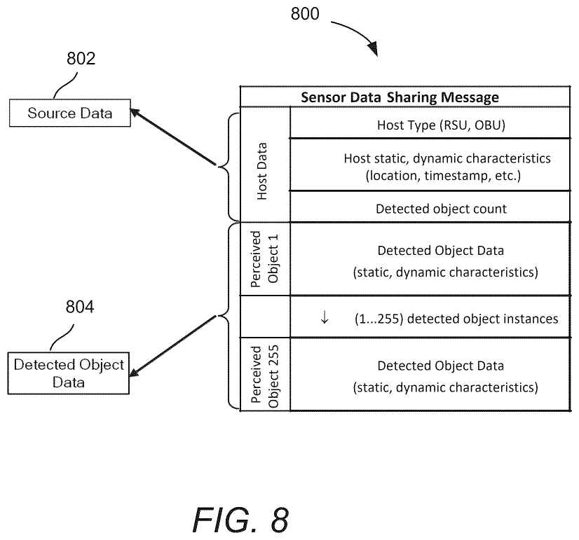

FIG. 8 illustrates an example of an SDSM message structure which includes source data and detected object data, according to aspects of the disclosure. In the example shown in FIG. 8, source data 802 may include, for example, host type (e.g., RSU or OBU), host static and/or dynamic characteristics (e.g., location, timestamp, etc.), and/or detected object count, as part of an SDSM 800. Detected object data 804, which is also part of the SDSM 800, may include static and/or dynamic characteristics of one or more detected objects, such as 1 . . . 255 detected object instances (denoted “Perceived Object 1” “Perceived Object 255”), as shown in FIG. 8.

In some aspects, detected NTN coverage data may include one or more following items of information:
Terrestrial network (TN) outage or TN limited service
NTN service provider
NTN anchor carrier EARFCN.
NTN PCI, TAC, and/or PLMN
Indication of whether the NTN jammed (Y/N)
Average NRSRP and/or CE level
Indication of whether the assistance-providing vehicular UE may act as a relay for SoS/P2P message over NTN (Y/N)
   Indication of whether the assistance-providing UE supports NTN features only for the GSO or NGSO scenario
   NTN class of service (corresponding to assistance-providing vehicular UE subscription)
   UE power class information for NTN

In some aspects, methods and systems according to aspects of the disclosure may be applicable to the following four scenarios where terrestrial network (e.g., cellular or WWAN) coverage is unavailable:

| | Vehicle | Vehicle | Vehicle | |
|---|---|---|---|---|
| | Seeking | Seeking | Seeking | Assisting |
| | Assistance: | Assistance: | Assistance: | Vehicle |
| Scenario | NTN Service | GNSS Fix | C-V2X | Role |
| Scenario 1 | Yes | Yes | Yes | Helps faster |
| | | | | NTN acquisition |
| | | | | for vehicle that |
| | | | | needs assistance |
| Scenario 2 | No | Yes | Yes | Helps relaying |
| | | | | SoS/P2P message |
| | | | | for vehicle that |
| | | | | needs assistance |
| Scenario 3 | Yes | No | Yes | Helps keeping |
| | | | | NTN session |
| | | | | longer on |
| | | | | vehicle that |
| | | | | needs assistance |
| Scenario 4 | No | No | Yes | Helps relaying |
| | | | | SoS/P2P message |
| | | | | for vehicle that |
| | | | | needs assistance |

In the first scenario (Scenario 1), the vehicle seeking assistance already has an NTN service subscription and a GNSS positioning fix. However, the assistance-seeking vehicle may still seek communication assistance from another vehicle for a faster NTN acquisition. In some aspects, NTN coverage data may be included in the SDSM/CPM message when terrestrial network coverage is likely not available and the assisting vehicle has detected NTN coverage.

In some aspects, the assisting vehicle may have been in the NTN mode for SoS or P2P sharing, and vehicles in proximity of the assisting vehicle may become aware of NTN coverage if they need to access NTN. In some aspects, NTN coverage data may expedite NTN system acquisition if NTN service needs to be invoked.

In the second scenario (Scenario 2), the assistance-seeking vehicle has a GNSS positioning fix but no NTN service (e.g., without an NTN service subscription or with a subscription but unable to access NTN service). In an emergency, that vehicle may seek assistance in relaying its SoS message when terrestrial network coverage is unavailable. In some situations, the assistance-seeking vehicle may have an NTN service subscription but is unable to acquire NTN service for various reasons (e.g., due to its location or inability to close an NTN link).

If any vehicle in proximity of the assistance-seeking vehicle has indicated that it is willing to act as a relay for the NTN service, then that vehicle may initiate a connection-oriented groupcast or unicast session. In some situations, it may initiate a connectionless groupcast as a fallback to connection-oriented groupcast or unicast.

In some aspects, the assistance-seeking vehicle may provide its SoS/P2P payload and vehicular UE information that may be relayed by the assistance-providing vehicle to send over the NTN. In some aspects, the assistance-seeking vehicle may share its coordinates that the assisting vehicle may use in its payload. However, the assisting vehicle may use its own location for TA pre-compensation. In some aspects, the assisting vehicle may also send downlink data to the assistance-seeking vehicle. In some aspects, an NTN application may be provided on the assistance-seeking vehicular UE, which may show this cooperative NTN mode of operation on its user interface (UI).

In the third scenario (Scenario 3), the assistance-seeking vehicle has an NTN service subscription but no GNSS positioning fix or no GNSS signal reception. In this scenario, the assistance-seeking vehicle may seek assistance in maintaining a longer duration for its NTN session. The assistance-seeking vehicle may be using its own NTN service but there is no GNSS positioning fix coexisting with the NTN service. In this scenario, without GNSS positioning, the vehicle may need to tear down its existing NTN session when its location information (for purposes such as TA pre-compensation) becomes stale.

Thus, the vehicle may need to obtain a new GNSS positioning fix in order to resume its NTN session.

In some aspects, one or more vehicles in proximity of the assistance-seeking vehicle may send their locations in C-V2X messages to the assistance-seeking vehicle. In some aspects, the assisting vehicular UE and assistance-seeking vehicular UE may be synchronized over a sidelink synchronization signal (SLSS) with the assisting vehicular UE acting as a synchronization reference (SyncRef) UE.

In some aspects, the assistance-seeking vehicle may perform ranging with one or more assisting vehicles in its vicinity to refine its existing location estimate, which may or may not be accurate (e.g., a location estimate based on dead reckoning (DR) or a previous positioning fix).

In the fourth scenario (Scenario 4), the assistance-seeking vehicle has neither a GNSS positioning fix nor NTN service, and is seeking assistance in relaying an SoS message in an emergency, for example. In this scenario, the assistance-seeking vehicle is in an area without terrestrial network coverage, and does not have an NTN service subscription, or has a subscription but is unable to acquire NTN service for various reasons (e.g., due to its location or inability to close an NTN link).

If any vehicle in proximity of the assistance-seeking vehicle has indicated its willingness to act as a relay for NTN service, then it may initiate a connection-oriented groupcast or unicast session. In some situations, it may initiate a connectionless groupcast as a fallback to connection-oriented groupcast or unicast.

In some aspects, the assistance-seeking vehicle may provide its SoS/P2P payload and vehicular UE information that may be relayed by the assistance-providing vehicle to transmit over the NTN. In some aspects, the assisting vehicular UE and assistance-seeking vehicular UE may be synchronized over an SLSS with the assisting vehicular UE acting as a SyncRef UE.

In some aspects, the assisting vehicle may perform ranging with the assistance-seeking vehicle and estimate the coordinates of the assistance-seeking vehicle which may be used in the message payload. In some aspects, the assisting vehicle may use its own location for TA pre-compensation. In some aspects, the assisting vehicle may also send downlink data to the assistance-seeking vehicle. In some aspects, an NTN application may be provided on the assistance-seeking vehicular UE, which may show this cooperative NTN mode of operation on its UI.

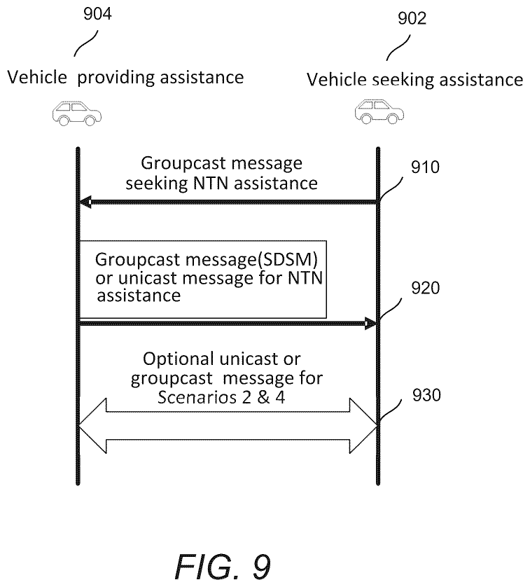

FIG. 9 illustrates an example call flow between a vehicle seeking assistance and a vehicle providing assistance, according to aspects of the disclosure. As illustrated in FIG. 9, at stage 910, a vehicle seeking assistance 902 sends a groupcast message seeking NTN assistance. A vehicle providing assistance 904, which may be in the vicinity of the vehicle seeking assistance 902, may receive the groupcast message seeking NTN assistance. At stage 920, the vehicle providing assistance 904 transmits a groupcast message (e.g., SDSM) or a unicast message indicating that it is capable of providing NTN communication assistance. At stage 930, one or more optional unicast or groupcast messages may be communicated between the vehicle seeking assistance 902 and the vehicle providing assistance 904 in the second and fourth scenarios (Scenario 2 and 4) described above. For example, SoS/P2P payload, vehicular UE information, and/or coordinates of the vehicle seeking assistance 902 may be transmitted to the vehicle providing assistance 904, and the vehicle providing assistance 904 may transmit downlink data to the vehicle seeking assistance 902.

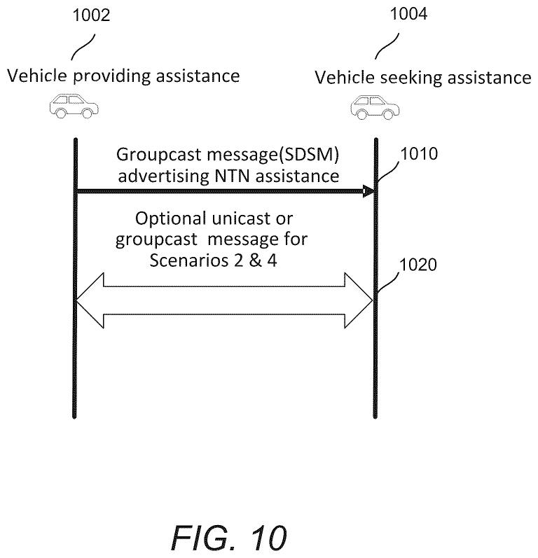

FIG. 10 illustrates an example call flow between a vehicle providing assistance and a vehicle seeking assistance, according to aspects of the disclosure. As illustrated in FIG. 10, at stage 1010, a vehicle providing assistance 1002 sends a groupcast message (e.g., SDSM) advertising NTN assistance. A vehicle seeking assistance 1004, which may be in the vicinity of the vehicle providing assistance 1002, may receive the groupcast message advertising NTN assistance. At stage 1020, one or more optional unicast or groupcast messages may be communicated between the vehicle providing assistance 1002 and the vehicle seeking assistance 1004 in the second and fourth scenarios (Scenario 2 and 4) described above. For example, SoS/P2P payload, vehicular UE information, and/or coordinates of the vehicle seeking assistance 1004 may be transmitted to the vehicle providing assistance 1002, and the vehicle providing assistance 1002 may transmit downlink data to the vehicle seeking assistance 1004.

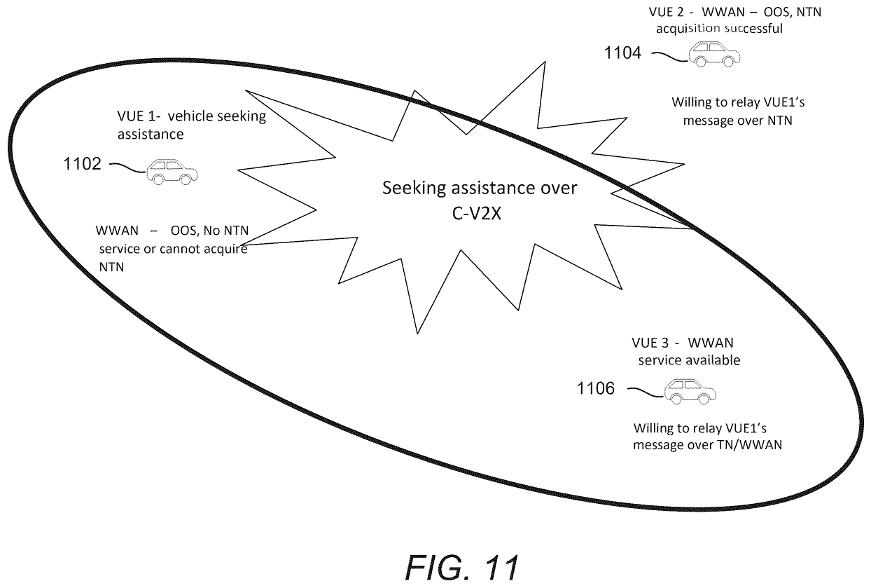

FIG. 11 illustrates an example environment for vehicles providing and seeking assistance, according to aspects of the disclosure. In the example illustrated in FIG. 11, it is assumed that a first vehicular UE 1102 (denoted “VUE 1”) cannot access terrestrial network (e.g., cellular or WWAN) service and does not have an NTN service subscription or cannot acquire NTN service. A second vehicular UE 1104 (denoted “VUE 2”) does not have terrestrial network (e.g., cellular or WWAN) service but has an NTN service subscription and is successful in NTN acquisition. The second vehicular UE 1104 may relay a communication message, such as an SoS message seeking emergency assistance, from the first vehicular UE 1102 over the NTN. A third vehicle 1106 (denoted “VUE 3”) has terrestrial network (e.g., cellular or WWAN) service available to it, and may relay a communication message from the first vehicular UE 1102 over the terrestrial network.

In some aspects, cellular network outage may be predicted based on PBA, RSRP, or another method of outage prediction. While there still is cellular network coverage, outage prediction may be used to plan on seeking NTN assistance before the actual outage occurs. NTN assistance planning may be performed over vehicle-to-network (V2N or Uu) while there is cellular coverage, or over LTE-V2X (i.e., PC5). In some aspects, NTN assistance planning may be provided from a cloud server where information is crowd-sourced from vehicles regarding NTN availability in specific zones.

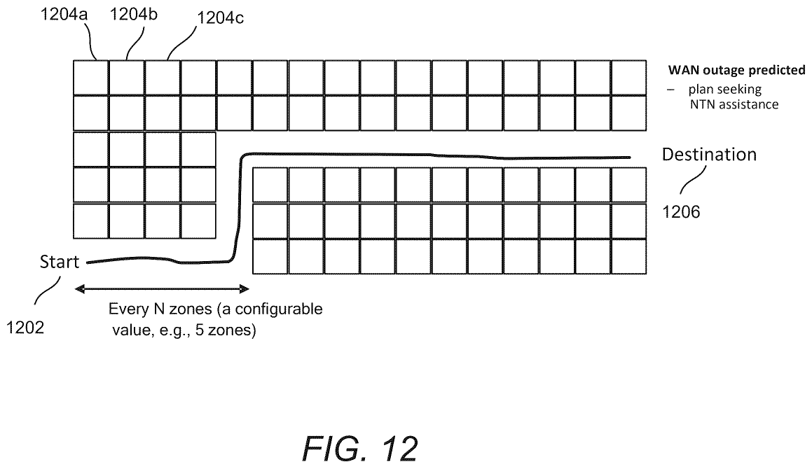

FIG. 12 illustrates an example of zone coverage for NTN assistance planning, according to aspects of the disclosure. In the example shown in FIG. 12, a vehicular UE (not shown) may start at a starting point 1202 and travel through a plurality of zones (squares such as 1204a, 1204b, 1204c, . . . ) to a destination 1206. In some aspects, the vehicular UE may be provided with NTN assistance planning at every Nth zone through which it has traveled. For example, NTN assistance planning may be provided by a cloud server, and NTN availability information may be communicated to the vehicular UE at every Nth zone. In some implementations, N may be a configurable value. For example, NTN assistance planning information may be transmitted to the vehicular UE at every fifth zone.

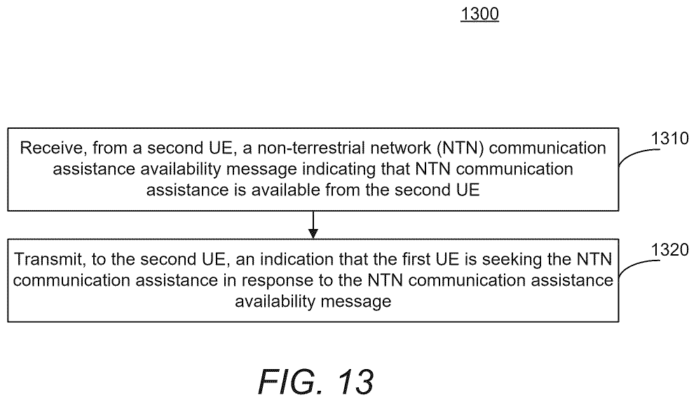

FIG. 13 illustrates an example method 1300 of wireless communication, according to aspects of the disclosure. In some aspects, method 1300 may be performed by a first UE (e.g., UE 302 described herein).

At 1310, the first UE may receive, from a second UE, a non-terrestrial network (NTN) communication assistance availability message indicating that NTN communication assistance is available from the second UE.

Means for performing the operation of block 1310 may include the processor(s), memory, or transceiver(s) of any of the UE 302 described herein. For example, the operation of block 1310 may be performed by the one or more WWAN transceivers 310, the one or more short-range wireless transceivers 320, the one or more processors 342, memory 340, and/or communication component 348, any or all of which may be considered means for performing this operation.

At 1320, the first UE may transmit, to the second UE, an indication that the first UE is seeking the NTN communication assistance in response to the NTN communication assistance availability message.

Means for performing the operation of block 1320 may include the processor(s), memory, or transceiver(s) of any of the UE 302 described herein. For example, the operation of block 1320 may be performed by the one or more WWAN transceivers 310, the one or more short-range wireless transceivers 320, the one or more processors 342, memory 340, and/or communication component 348, any or all of which may be considered means for performing this operation.

Method 1300 may include additional implementations, such as any single implementation or any combination of implementations described below and/or in connection with one or more other processes described elsewhere herein.

In some aspects, the NTN communication assistance availability message is a sensor data sharing message (SDSM) or a collective perception message (CPM).

In some aspects, the NTN communication assistance availability message includes one or more information elements (IEs) including terrestrial network out-of-service (OOS) information, an NTN service provider, NTN availability information, average narrowband reference signal received power (NRSRP), an indication of jamming of NTN frequency bands, or any combination thereof.

In some aspects, method 1300 includes transmitting a groupcast message seeking the NTN communication assistance.

In some aspects, method 1300 includes establishing a cellular vehicle-to-everything (C-V2X) communication with the second UE.

In some aspects, method 1300 includes transmitting, to the second UE, an emergency message via the cellular C-V2X communication.

In some aspects, method 1300 includes determining whether an NTN communication is available at the first UE, determining whether a global navigation satellite system (GNSS) signal is present, and transmitting, to the second UE, an indication that the first UE is present within a communication range of the second UE based on a determination that the NTN communication is available at the first UE and a determination that the GNSS signal is present.

In some aspects, method 1300 includes determining whether an NTN communication is available at the first UE, determining whether a global navigation satellite system (GNSS) signal is present, and transmitting, to the second UE, an indication that the first UE is seeking positioning assistance from the second UE based on a determination that the NTN communication is available at the first UE and a determination that the GNSS signal is not present.

In some aspects, the first UE is a vehicle.

Although FIG. 13 shows example blocks of method 1300, in some implementations, method 1300 may include additional blocks, fewer blocks, different blocks, or differently arranged blocks than those depicted in FIG. 13. Additionally, or alternatively, two or more of the blocks of method 1300 may be performed in parallel, or performed in a sequence different from the sequence listed in FIG. 13.

As will be appreciated, a technical advantage of the method 1300 is that, by utilizing sensor data sharing or collective perception capabilities of vehicle-to-everything (V2X) communications, a vehicular UE in an area without terrestrial cellular network coverage may seek NTN communication assistance via another vehicular UE, in an emergency or non-emergency situation, for example.

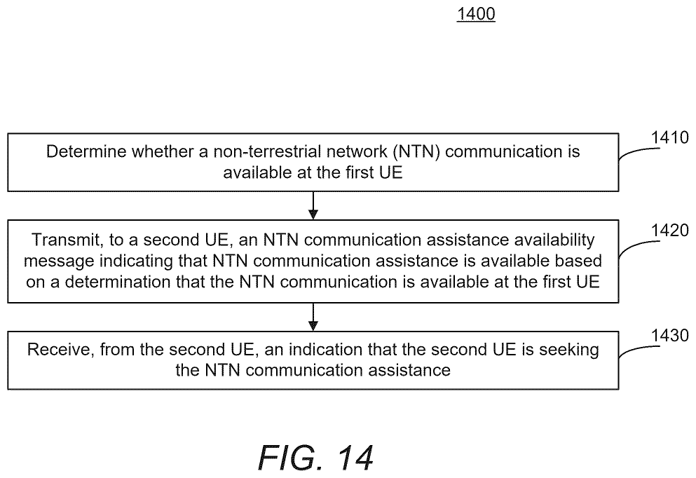

FIG. 14 illustrates an example method 1400 of wireless communication, according to aspects of the disclosure. In some aspects, method 1400 may be performed by a first UE (e.g., UE 302 described herein).

At 1410, the first UE may determine whether a non-terrestrial network (NTN) communication is available at the first UE.

Means for performing the operation of block 1410 may include the processor(s), memory, or transceiver(s) of any of the UE 302 described herein. For example, the operation of block 1410 may be performed by the one or more WWAN transceivers 310, the one or more short-range wireless transceivers 320, the one or more processors 342, memory 340, and/or communication component 348, any or all of which may be considered means for performing this operation.

At 1420, the first UE may transmit, to a second UE, an NTN communication assistance availability message indicating that NTN communication assistance is available based on a determination that the NTN communication is available at the first UE.

Means for performing the operation of block 1420 may include the processor(s), memory, or transceiver(s) of any of the UE 302 described herein. For example, the operation of block 1420 may be performed by the one or more WWAN transceivers 310, the one or more short-range wireless transceivers 320, the one or more processors 342, memory 340, and/or communication component 348, any or all of which may be considered means for performing this operation.

At 1430, the first UE may receive, from the second UE, an indication that the second UE is seeking the NTN communication assistance.

Means for performing the operation of block 1430 may include the processor(s), memory, or transceiver(s) of any of the UE 302 described herein. For example, the operation of block 1430 may be performed by the one or more WWAN transceivers 310, the one or more short-range wireless transceivers 320, the one or more processors 342, memory 340, and/or communication component 348, any or all of which may be considered means for performing this operation.

Method 1400 may include additional implementations, such as any single implementation or any combination of implementations described below and/or in connection with one or more other processes described elsewhere herein.

In some aspects, the NTN communication assistance availability message is a sensor data sharing message (SDSM) or a collective perception message (CPM).

In some aspects, the NTN communication assistance availability message includes one or more information elements (IEs) including terrestrial network out-of-service (OOS) information, an NTN service provider, NTN availability information, average narrowband reference signal received power (NRSRP), an indication of jamming of NTN frequency bands, or any combination thereof.

In some aspects, method 1400 includes receiving, from the second UE, a groupcast message seeking the NTN communication assistance.

In some aspects, method 1400 includes establishing a cellular vehicle-to-everything (C-V2X) communication with the second UE.

In some aspects, method 1400 includes receiving, from the second UE, an emergency message via the cellular C-V2X communication.

In some aspects, method 1400 includes relaying, to a network node, the emergency message via the NTN communication.

In some aspects, method 1400 includes receiving, from the second UE, an indication that the first UE is present within a communication range of the second UE.

In some aspects, method 1400 includes receiving, from the second UE, an indication that the second UE is seeking positioning assistance from the first UE, and transmitting, to the second UE, positioning assistance information in response to the indication that the second UE is seeking the positioning assistance.

In some aspects, the positioning assistance information includes ranging information.

In some aspects, method 1400 includes transmitting, to the second UE, a sidelink synchronization signal (SLSS) in response to the indication that the second UE is seeking the positioning assistance.

In some aspects, the first UE is a vehicle.

Although FIG. 14 shows example blocks of method 1400, in some implementations, method 1400 may include additional blocks, fewer blocks, different blocks, or differently arranged blocks than those depicted in FIG. 14. Additionally, or alternatively, two or more of the blocks of method 1400 may be performed in parallel, or performed in a sequence different from the sequence listed in FIG. 14.

As will be appreciated, a technical advantage of the method 1400 is that, by utilizing sensor data sharing or collective perception capabilities of vehicle-to-everything (V2X) communications, a vehicular UE that has an NTN communication assistance capability in an area without terrestrial cellular network coverage may provide communication assistance to another vehicular UE, in an emergency or non-emergency situation, for example.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed at a first user equipment (UE), comprising: receiving, from a second UE, a non-terrestrial network (NTN) communication assistance availability message indicating that NTN communication assistance is available from the second UE; and transmitting, to the second UE, an indication that the first UE is seeking the NTN communication assistance in response to the NTN communication assistance availability message.

Clause 2. The method of clause 1, wherein the NTN communication assistance availability message is a sensor data sharing message (SDSM) or a collective perception message (CPM).

Clause 3. The method of any of clauses 1 to 2, wherein the NTN communication assistance availability message comprises one or more information elements (IEs) comprising: terrestrial network out-of-service (OOS) information; an NTN service provider; NTN availability information; average narrowband reference signal received power (NRSRP); an indication of jamming of NTN frequency bands; or any combination thereof.

Clause 4. The method of any of clauses 1 to 3, further comprising: transmitting a groupcast message seeking the NTN communication assistance.

Clause 5. The method of any of clauses 1 to 4, further comprising: establishing a cellular vehicle-to-everything (C-V2X) communication with the second UE.

Clause 6. The method of clause 5, further comprising: transmitting, to the second UE, an emergency message via the cellular C-V2X communication.

Clause 7. The method of any of clauses 1 to 6, further comprising: determining whether an NTN communication is available at the first UE; determining whether a global navigation satellite system (GNSS) signal is present; and transmitting, to the second UE, an indication that the first UE is present within a communication range of the second UE based on a determination that the NTN communication is available at the first UE and a determination that the GNSS signal is present.

Clause 8. The method of any of clauses 1 to 7, further comprising: determining whether an NTN communication is available at the first UE; determining whether a global navigation satellite system (GNSS) signal is present; and transmitting, to the second UE, an indication that the first UE is seeking positioning assistance from the second UE based on a determination that the NTN communication is available at the first UE and a determination that the GNSS signal is not present.

Clause 9. The method of any of clauses 1 to 8, wherein the first UE is a vehicle.

Clause 10. A method of wireless communication performed at a first user equipment (UE), comprising: determining whether a non-terrestrial network (NTN) communication is available at the first UE; transmitting, to a second UE, an NTN communication assistance availability message indicating that NTN communication assistance is available based on a determination that the NTN communication is available at the first UE; and receiving, from the second UE, an indication that the second UE is seeking the NTN communication assistance.

Clause 11. The method of clause 10, wherein the NTN communication assistance availability message is a sensor data sharing message (SDSM) or a collective perception message (CPM).

Clause 12. The method of any of clauses 10 to 11, wherein the NTN communication assistance availability message comprises one or more information elements (IEs) comprising: terrestrial network out-of-service (OOS) information; an NTN service provider; NTN availability information; average narrowband reference signal received power (NRSRP); an indication of jamming of NTN frequency bands; or any combination thereof.

Clause 13. The method of any of clauses 10 to 12, further comprising: receiving, from the second UE, a groupcast message seeking the NTN communication assistance.

Clause 14. The method of any of clauses 10 to 13, further comprising: establishing a cellular vehicle-to-everything (C-V2X) communication with the second UE.

Clause 15. The method of clause 14, further comprising: receiving, from the second UE, an emergency message via the cellular C-V2X communication.

Clause 16. The method of clause 15, further comprising: relaying, to a network node, the emergency message via the NTN communication.

Clause 17. The method of any of clauses 10 to 16, further comprising: receiving, from the second UE, an indication that the first UE is present within a communication range of the second UE.

Clause 18. The method of any of clauses 10 to 17, further comprising: receiving, from the second UE, an indication that the second UE is seeking positioning assistance from the first UE; and transmitting, to the second UE, positioning assistance information in response to the indication that the second UE is seeking the positioning assistance.

Clause 19. The method of clause 18, wherein the positioning assistance information includes ranging information.

Clause 20. The method of any of clauses 18 to 19, further comprising: transmitting, to the second UE, a sidelink synchronization signal (SLSS) in response to the indication that the second UE is seeking the positioning assistance.

Clause 21. The method of any of clauses 10 to 20, wherein the first UE is a vehicle.

Clause 22. A first user equipment (UE), comprising: one or more memories; one or more transceivers; and one or more processors communicatively coupled to the one or more memories and the one or more transceivers, the one or more processors, either alone or in combination, configured to: receive, via the one or more transceivers, from a second UE, a non-terrestrial network (NTN) communication assistance availability message indicating that NTN communication assistance is available from the second UE; and transmit, via the one or more transceivers, to the second UE, an indication that the first UE is seeking the NTN communication assistance in response to the NTN communication assistance availability message.

Clause 23. The first UE of clause 22, wherein the NTN communication assistance availability message is a sensor data sharing message (SDSM) or a collective perception message (CPM).

Clause 24. The first UE of any of clauses 22 to 23, wherein the NTN communication assistance availability message comprises one or more information elements (IEs) comprising: terrestrial network out-of-service (OOS) information; an NTN service provider; NTN availability information; average narrowband reference signal received power (NRSRP); an indication of jamming of NTN frequency bands; or any combination thereof.

Clause 25. The first UE of any of clauses 22 to 24, wherein the one or more processors, either alone or in combination, are further configured to: transmit, via the one or more transceivers, a groupcast message seeking the NTN communication assistance.

Clause 26. The first UE of any of clauses 22 to 25, wherein the one or more processors, either alone or in combination, are further configured to: establish a cellular vehicle-to-everything (C-V2X) communication with the second UE.

Clause 27. The first UE of clause 26, wherein the one or more processors, either alone or in combination, are further configured to: transmit, via the one or more transceivers, to the second UE, an emergency message via the cellular C-V2X communication.

Clause 28. The first UE of any of clauses 22 to 27, wherein the one or more processors, either alone or in combination, are further configured to: determine whether an NTN communication is available at the first UE; determine whether a global navigation satellite system (GNSS) signal is present; and transmit, via the one or more transceivers, to the second UE, an indication that the first UE is present within a communication range of the second UE based on a determination that the NTN communication is available at the first UE and a determination that the GNSS signal is present.

Clause 29. The first UE of any of clauses 22 to 28, wherein the one or more processors, either alone or in combination, are further configured to: determine whether an NTN communication is available at the first UE; determine whether a global navigation satellite system (GNSS) signal is present; and transmit, via the one or more transceivers, to the second UE, an indication that the first UE is seeking positioning assistance from the second UE based on a determination that the NTN communication is available at the first UE and a determination that the GNSS signal is not present.

Clause 30. The first UE of any of clauses 22 to 29, wherein the first UE is a vehicle.

Clause 31. A first user equipment (UE), comprising: one or more memories; one or more transceivers; and one or more processors communicatively coupled to the one or more memories and the one or more transceivers, the one or more processors, either alone or in combination, configured to: determine whether a non-terrestrial network (NTN) communication is available at the first UE; transmit, via the one or more transceivers, to a second UE, an NTN communication assistance availability message indicating that NTN communication assistance is available based on a determination that the NTN communication is available at the first UE; and receive, via the one or more transceivers, from the second UE, an indication that the second UE is seeking the NTN communication assistance.

Clause 32. The first UE of clause 31, wherein the NTN communication assistance availability message is a sensor data sharing message (SDSM) or a collective perception message (CPM).

Clause 33. The first UE of any of clauses 31 to 32, wherein the NTN communication assistance availability message comprises one or more information elements (IEs) comprising: terrestrial network out-of-service (OOS) information; an NTN service provider; NTN availability information; average narrowband reference signal received power (NRSRP); an indication of jamming of NTN frequency bands; or any combination thereof.

Clause 34. The first UE of any of clauses 31 to 33, wherein the one or more processors, either alone or in combination, are further configured to: receive, via the one or more transceivers, from the second UE, a groupcast message seeking the NTN communication assistance.

Clause 35. The first UE of any of clauses 31 to 34, wherein the one or more processors, either alone or in combination, are further configured to: establish a cellular vehicle-to-everything (C-V2X) communication with the second UE.

Clause 36. The first UE of clause 35, wherein the one or more processors, either alone or in combination, are further configured to: receive, via the one or more transceivers, from the second UE, an emergency message via the cellular C-V2X communication.

Clause 37. The first UE of clause 36, wherein the one or more processors, either alone or in combination, are further configured to: relay, to a network node, the emergency message via the NTN communication.

Clause 38. The first UE of any of clauses 31 to 37, wherein the one or more processors, either alone or in combination, are further configured to: receive, via the one or more transceivers, from the second UE, an indication that the first UE is present within a communication range of the second UE.

Clause 39. The first UE of any of clauses 31 to 38, wherein the one or more processors, either alone or in combination, are further configured to: receive, via the one or more transceivers, from the second UE, an indication that the second UE is seeking positioning assistance from the first UE; and transmit, via the one or more transceivers, to the second UE, positioning assistance information in response to the indication that the second UE is seeking the positioning assistance.

Clause 40. The first UE of clause 39, wherein the positioning assistance information includes ranging information.

Clause 41. The first UE of any of clauses 39 to 40, wherein the one or more processors, either alone or in combination, are further configured to: transmit, via the one or more transceivers, to the second UE, a sidelink synchronization signal (SLSS) in response to the indication that the second UE is seeking the positioning assistance.

Clause 42. The first UE of any of clauses 31 to 41, wherein the first UE is a vehicle.

Clause 43. A first user equipment (UE), comprising: means for receiving, from a second UE, a non-terrestrial network (NTN) communication assistance availability message indicating that NTN communication assistance is available from the second UE; and means for transmitting, to the second UE, an indication that the first UE is seeking the NTN communication assistance in response to the NTN communication assistance availability message.

Clause 44. The first UE of clause 43, wherein the NTN communication assistance availability message is a sensor data sharing message (SDSM) or a collective perception message (CPM).

Clause 45. The first UE of any of clauses 43 to 44, wherein the NTN communication assistance availability message comprises one or more information elements (IEs) comprising: terrestrial network out-of-service (OOS) information; an NTN service provider; NTN availability information; average narrowband reference signal received power (NRSRP); an indication of jamming of NTN frequency bands; or any combination thereof.

Clause 46. The first UE of any of clauses 43 to 45, further comprising: means for transmitting a groupcast message seeking the NTN communication assistance.

Clause 47. The first UE of any of clauses 43 to 46, further comprising: means for establishing a cellular vehicle-to-everything (C-V2X) communication with the second UE.

Clause 48. The first UE of clause 47, further comprising: means for transmitting, to the second UE, an emergency message via the cellular C-V2X communication.

Clause 49. The first UE of any of clauses 43 to 48, further comprising: means for determining whether an NTN communication is available at the first UE; means for determining whether a global navigation satellite system (GNSS) signal is present; and means for transmitting, to the second UE, an indication that the first UE is present within a communication range of the second UE based on a determination that the NTN communication is available at the first UE and a determination that the GNSS signal is present.

Clause 50. The first UE of any of clauses 43 to 49, further comprising: means for determining whether an NTN communication is available at the first UE; means for determining whether a global navigation satellite system (GNSS) signal is present; and means for transmitting, to the second UE, an indication that the first UE is seeking positioning assistance from the second UE based on a determination that the NTN communication is available at the first UE and a determination that the GNSS signal is not present.

Clause 51. The first UE of any of clauses 43 to 50, wherein the first UE is a vehicle.

Clause 52. A first user equipment (UE), comprising: means for determining whether a non-terrestrial network (NTN) communication is available at the first UE; means for transmitting, to a second UE, an NTN communication assistance availability message indicating that NTN communication assistance is available based on a determination that the NTN communication is available at the first UE; and means for receiving, from the second UE, an indication that the second UE is seeking the NTN communication assistance.

Clause 53. The first UE of clause 52, wherein the NTN communication assistance availability message is a sensor data sharing message (SDSM) or a collective perception message (CPM).

Clause 54. The first UE of any of clauses 52 to 53, wherein the NTN communication assistance availability message comprises one or more information elements (IEs) comprising: terrestrial network out-of-service (OOS) information; an NTN service provider; NTN availability information; average narrowband reference signal received power (NRSRP); an indication of jamming of NTN frequency bands; or any combination thereof.

Clause 55. The first UE of any of clauses 52 to 54, further comprising: means for receiving, from the second UE, a groupcast message seeking the NTN communication assistance.

Clause 56. The first UE of any of clauses 52 to 55, further comprising: means for establishing a cellular vehicle-to-everything (C-V2X) communication with the second UE.

Clause 57. The first UE of clause 56, further comprising: means for receiving, from the second UE, an emergency message via the cellular C-V2X communication.

Clause 58. The first UE of clause 57, further comprising: means for relaying, to a network node, the emergency message via the NTN communication.

Clause 59. The first UE of any of clauses 52 to 58, further comprising: means for receiving, from the second UE, an indication that the first UE is present within a communication range of the second UE.

Clause 60. The first UE of any of clauses 52 to 59, further comprising: means for receiving, from the second UE, an indication that the second UE is seeking positioning assistance from the first UE; and means for transmitting, to the second UE, positioning assistance information in response to the indication that the second UE is seeking the positioning assistance.

Clause 61. The first UE of clause 60, wherein the positioning assistance information includes ranging information.

Clause 62. The first UE of any of clauses 60 to 61, further comprising: means for transmitting, to the second UE, a sidelink synchronization signal (SLSS) in response to the indication that the second UE is seeking the positioning assistance.

Clause 63. The first UE of any of clauses 52 to 62, wherein the first UE is a vehicle.

Clause 64. A non-transitory computer-readable medium stores computer-executable instructions that, when executed by a first user equipment (UE), cause the first UE to: receive, from a second UE, a non-terrestrial network (NTN) communication assistance availability message indicating that NTN communication assistance is available from the second UE; and transmit, to the second UE, an indication that the first UE is seeking the NTN communication assistance in response to the NTN communication assistance availability message.

Clause 65. The non-transitory computer-readable medium of clause 64, wherein the NTN communication assistance availability message is a sensor data sharing message (SDSM) or a collective perception message (CPM).

Clause 66. The non-transitory computer-readable medium of any of clauses 64 to 65, wherein the NTN communication assistance availability message comprises one or more information elements (IEs) comprising: terrestrial network out-of-service (OOS) information; an NTN service provider; NTN availability information; average narrowband reference signal received power (NRSRP); an indication of jamming of NTN frequency bands; or any combination thereof.

Clause 67. The non-transitory computer-readable medium of any of clauses 64 to 66, further comprising computer-executable instructions that, when executed by the first UE, cause the first UE to: transmit a groupcast message seeking the NTN communication assistance.

Clause 68. The non-transitory computer-readable medium of any of clauses 64 to 67, further comprising computer-executable instructions that, when executed by the first UE, cause the first UE to: establish a cellular vehicle-to-everything (C-V2X) communication with the second UE.

Clause 69. The non-transitory computer-readable medium of clause 68, further comprising computer-executable instructions that, when executed by the first UE, cause the first UE to: transmit, to the second UE, an emergency message via the cellular C-V2X communication.

Clause 70. The non-transitory computer-readable medium of any of clauses 64 to 69, further comprising computer-executable instructions that, when executed by the first UE, cause the first UE to: determine whether an NTN communication is available at the first UE; determine whether a global navigation satellite system (GNSS) signal is present; and transmit, to the second UE, an indication that the first UE is present within a communication range of the second UE based on a determination that the NTN communication is available at the first UE and a determination that the GNSS signal is present.

Clause 71. The non-transitory computer-readable medium of any of clauses 64 to 70, further comprising computer-executable instructions that, when executed by the first UE, cause the first UE to: determine whether an NTN communication is available at the first UE; determine whether a global navigation satellite system (GNSS) signal is present; and transmit, to the second UE, an indication that the first UE is seeking positioning assistance from the second UE based on a determination that the NTN communication is available at the first UE and a determination that the GNSS signal is not present.

Clause 72. The non-transitory computer-readable medium of any of clauses 64 to 71, wherein the first UE is a vehicle.

Clause 73. A non-transitory computer-readable medium stores computer-executable instructions that, when executed by a first user equipment (UE), cause the first UE to: determine whether a non-terrestrial network (NTN) communication is available at the first UE; transmit, to a second UE, an NTN communication assistance availability message indicating that NTN communication assistance is available based on a determination that the NTN communication is available at the first UE; and receive, from the second UE, an indication that the second UE is seeking the NTN communication assistance.

Clause 74. The non-transitory computer-readable medium of clause 73, wherein the NTN communication assistance availability message is a sensor data sharing message (SDSM) or a collective perception message (CPM).

Clause 75. The non-transitory computer-readable medium of any of clauses 73 to 74, wherein the NTN communication assistance availability message comprises one or more information elements (IEs) comprising: terrestrial network out-of-service (OOS) information; an NTN service provider; NTN availability information; average narrowband reference signal received power (NRSRP); an indication of jamming of NTN frequency bands; or any combination thereof.

Clause 76. The non-transitory computer-readable medium of any of clauses 73 to 75, further comprising computer-executable instructions that, when executed by the first UE, cause the first UE to: receive, from the second UE, a groupcast message seeking the NTN communication assistance.

Clause 77. The non-transitory computer-readable medium of any of clauses 73 to 76, further comprising computer-executable instructions that, when executed by the first UE, cause the first UE to: establish a cellular vehicle-to-everything (C-V2X) communication with the second UE.

Clause 78. The non-transitory computer-readable medium of clause 77, further comprising computer-executable instructions that, when executed by the first UE, cause the first UE to: receive, from the second UE, an emergency message via the cellular C-V2X communication.

Clause 79. The non-transitory computer-readable medium of clause 78, further comprising computer-executable instructions that, when executed by the first UE, cause the first UE to: relay, to a network node, the emergency message via the NTN communication.

Clause 80. The non-transitory computer-readable medium of any of clauses 73 to 79, further comprising computer-executable instructions that, when executed by the first UE, cause the first UE to: receive, from the second UE, an indication that the first UE is present within a communication range of the second UE.

Clause 81. The non-transitory computer-readable medium of any of clauses 73 to 80, further comprising computer-executable instructions that, when executed by the first UE, cause the first UE to: receive, from the second UE, an indication that the second UE is seeking positioning assistance from the first UE; and transmit, to the second UE, positioning assistance information in response to the indication that the second UE is seeking the positioning assistance.

Clause 82. The non-transitory computer-readable medium of clause 81, wherein the positioning assistance information includes ranging information.

Clause 83. The non-transitory computer-readable medium of any of clauses 81 to 82, further comprising computer-executable instructions that, when executed by the first UE, cause the first UE to: transmit, to the second UE, a sidelink synchronization signal (SLSS) in response to the indication that the second UE is seeking the positioning assistance.

Clause 84. The non-transitory computer-readable medium of any of clauses 73 to 83, wherein the first UE is a vehicle.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A first user equipment (UE), comprising:
one or more memories;
one or more transceivers; and
one or more processors communicatively coupled to the one or more memories and the one or more transceivers, the one or more processors, either alone or in combination, configured to:
receive, via the one or more transceivers, from a second UE, a non-terrestrial network (NTN) communication assistance availability message indicating that NTN communication assistance is available from the second UE; and
transmit, via the one or more transceivers, to the second UE, an indication that the first UE is seeking the NTN communication assistance in response to the NTN communication assistance availability message.

2. The first UE of claim 1, wherein the NTN communication assistance availability message is a sensor data sharing message (SDSM) or a collective perception message (CPM).

3. The first UE of claim 1, wherein the NTN communication assistance availability message comprises one or more information elements (IEs) comprising:
terrestrial network out-of-service (OOS) information;
an NTN service provider;
NTN availability information;
average narrowband reference signal received power (NRSRP);
an indication of jamming of NTN frequency bands;
or any combination thereof.

4. The first UE of claim 1, wherein the one or more processors, either alone or in combination, are further configured to:
transmit, via the one or more transceivers, a groupcast message seeking the NTN communication assistance.

5. The first UE of claim 1, wherein the one or more processors, either alone or in combination, are further configured to:
establish a cellular vehicle-to-everything (C-V2X) communication with the second UE.

6. The first UE of claim 5, wherein the one or more processors, either alone or in combination, are further configured to:
transmit, via the one or more transceivers, to the second UE, an emergency message via the cellular C-V2X communication.

7. The first UE of claim 1, wherein the one or more processors, either alone or in combination, are further configured to:
determine whether an NTN communication is available at the first UE;
determine whether a global navigation satellite system (GNSS) signal is present; and
transmit, via the one or more transceivers, to the second UE, an indication that the first UE is present within a communication range of the second UE based on a determination that the NTN communication is available at the first UE and a determination that the GNSS signal is present.

8. The first UE of claim 1, wherein the one or more processors, either alone or in combination, are further configured to:
determine whether an NTN communication is available at the first UE;
determine whether a global navigation satellite system (GNSS) signal is present; and
transmit, via the one or more transceivers, to the second UE, an indication that the first UE is seeking positioning assistance from the second UE based on a determination that the NTN communication is available at the first UE and a determination that the GNSS signal is not present.

9. The first UE of claim 1, wherein the first UE is a vehicle.

10. A first user equipment (UE), comprising:
one or more memories;
one or more transceivers; and
one or more processors communicatively coupled to the one or more memories and the one or more transceivers, the one or more processors, either alone or in combination, configured to:
determine that a non-terrestrial network (NTN) communication is available at the first UE;
transmit, via the one or more transceivers, to a second UE, an NTN communication assistance availability message indicating that NTN communication assistance is available based on a determination that the NTN communication is available at the first UE; and
receive, via the one or more transceivers, from the second UE, an indication that the second UE is seeking the NTN communication assistance.

11. The first UE of claim 10, wherein the NTN communication assistance availability message is a sensor data sharing message (SDSM) or a collective perception message (CPM).

12. The first UE of claim 10, wherein the NTN communication assistance availability message comprises one or more information elements (IEs) comprising:
terrestrial network out-of-service (OOS) information;
an NTN service provider;
NTN availability information;
average narrowband reference signal received power (NRSRP);
an indication of jamming of NTN frequency bands;
or any combination thereof.

13. The first UE of claim 10, wherein the one or more processors, either alone or in combination, are further configured to:
receive, via the one or more transceivers, from the second UE, a groupcast message seeking the NTN communication assistance.

14. The first UE of claim 10, wherein the one or more processors, either alone or in combination, are further configured to:
establish a cellular vehicle-to-everything (C-V2X) communication with the second UE.

15. The first UE of claim 14, wherein the one or more processors, either alone or in combination, are further configured to:
receive, via the one or more transceivers, from the second UE, an emergency message via the cellular C-V2X communication.

16. The first UE of claim 15, wherein the one or more processors, either alone or in combination, are further configured to:
relay, to a network node, the emergency message via the NTN communication.

17. The first UE of claim 10, wherein the one or more processors, either alone or in combination, are further configured to:
receive, via the one or more transceivers, from the second UE, an indication that the first UE is present within a communication range of the second UE.

18. The first UE of claim 10, wherein the one or more processors, either alone or in combination, are further configured to:
receive, via the one or more transceivers, from the second UE, an indication that the second UE is seeking positioning assistance from the first UE; and
transmit, via the one or more transceivers, to the second UE, positioning assistance information in response to the indication that the second UE is seeking the positioning assistance.

19. The first UE of claim 18, wherein the positioning assistance information includes ranging information.

20. The first UE of claim 18, wherein the one or more processors, either alone or in combination, are further configured to:
transmit, via the one or more transceivers, to the second UE, a sidelink synchronization signal (SLSS) in response to the indication that the second UE is seeking the positioning assistance.

21. The first UE of claim 10, wherein the first UE is a vehicle.

22. A method of wireless communication performed at a first user equipment (UE), comprising:
receiving, from a second UE, a non-terrestrial network (NTN) communication assistance availability message indicating that NTN communication assistance is available from the second UE; and
transmitting, to the second UE, an indication that the first UE is seeking the NTN communication assistance in response to the NTN communication assistance availability message.

23. The method of claim 22, further comprising:
establishing a cellular vehicle-to-everything (C-V2X) communication with the second UE.

24. The method of claim 22, further comprising:
determining whether an NTN communication is available at the first UE;
determining whether a global navigation satellite system (GNSS) signal is present; and
transmitting, to the second UE, an indication that the first UE is present within a communication range of the second UE based on a determination that the NTN communication is available at the first UE and a determination that the GNSS signal is present.

25. The method of claim 22, further comprising:
determining whether an NTN communication is available at the first UE;
determining whether a global navigation satellite system (GNSS) signal is present; and
transmitting, to the second UE, an indication that the first UE is seeking positioning assistance from the second UE based on a determination that the NTN communication is available at the first UE and a determination that the GNSS signal is not present.

26. A method of wireless communication performed at a first user equipment (UE), comprising:
determining that a non-terrestrial network (NTN) communication is available at the first UE;
transmitting, to a second UE, an NTN communication assistance availability message indicating that NTN communication assistance is available based on a determination that the NTN communication is available at the first UE; and
receiving, from the second UE, an indication that the second UE is seeking the NTN communication assistance.

27. The method of claim 26, further comprising:
establishing a cellular vehicle-to-everything (C-V2X) communication with the second UE.

28. The method of claim 26, further comprising:
receiving, from the second UE, an indication that the first UE is present within a communication range of the second UE.

29. The method of claim 26, further comprising:
receiving, from the second UE, an indication that the second UE is seeking positioning assistance from the first UE; and
transmitting, to the second UE, positioning assistance information in response to the indication that the second UE is seeking the positioning assistance.

30. The method of claim 29, further comprising:
transmitting, to the second UE, a sidelink synchronization signal (SLSS) in response to the indication that the second UE is seeking the positioning assistance.
